(19) United States
(12) Patent Application Publication
(10) Pub. No.: US 2017/0227096 A1
(43) Pub. Date: Aug. 10, 2017

(54) VARIABLE RATIO CRANKSHAFT TRANSMISSION

(71) Applicant: Vincent Jean Bellis, Dubai (AE)

(72) Inventor: Vincent Jean Bellis, Dubai (AE)

(21) Appl. No.: 15/040,994

(22) Filed: Feb. 10, 2016

(51) Int. Cl. F16H 21/14; F16H 25/20; F16H 19/06; B62M 15/00; B62M 25/08

(52) U.S. Cl. CPC F16H 21/14; B62M 15/00; B62M 25/08; F16H 19/06; F16H 25/20; F16H 2019/0681

(57) ABSTRACT

The system of the preferred embodiments is a transmission including: at least two axle segments; at least one crank arm attached at one end to each axle segment, wherein the space between the at least two crank arms has a gap between the at least two axle segments; a connecting rod; a connecting axle rotatably connected to one end of the connecting rod, wherein the connecting axle is attached at either end to the at least two crank arms; an actuator adapted to move the attachment point between the connecting axle and the at least two crank arms up and down the length of the at least two crank arms; at least one of a wheel and a crank arm with a pivot axle connected at least one of near the periphery of the wheel and near the end of the crank arm, wherein the distal end of the connecting rod is rotatably connected to the pivot axle; a one way clutch connected to the wheel and connected to a rear axle; a drive gear connected to the rear axle and adapted to output drive power. The transmission of the first preferred embodiments is preferably designed to provide a compact transmission that does not use a derailleur and limits or does not use a chain at all, while being suitable for use on human powered vehicles like bicycles and having the potential in some variations of providing continuous variability in ratio of input axle rotation to output axle rotation. The system of the preferred embodiments may, however, be used for any suitable purpose.

### BRIEF DESCRIPTION OF THE FIGURES

FIG. 1 is a schematic representation of one variation of the system of the preferred embodiments with at least three axle segments and a cam designed to trigger a switch to synchronize the actuator at a given angular position.

FIG. 2 is a schematic representation of one variation of the system of the preferred embodiments viewed from the side, with a cam designed to trigger a switch to synchronize the actuator at a given angular position.

FIG. 3 is a schematic representation of one variation of the system of the preferred embodiments viewed from the side, with a cam designed to trigger a switch to synchronize the actuator at a given angular position, shown with the connecting rod aligned with the center of the rear axle at what could be referred to as the 180 degree position, and shown with a cable drive mechanism for the actuator.

FIG. 4 is a schematic representation of one variation of the system of the preferred embodiments viewed from the side, with a lead screw and threaded nut for the actuator.

FIG. 5 is a schematic representation of one variation of the system of the preferred embodiments viewed from the side, with a second clutch that can be selectively activated.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

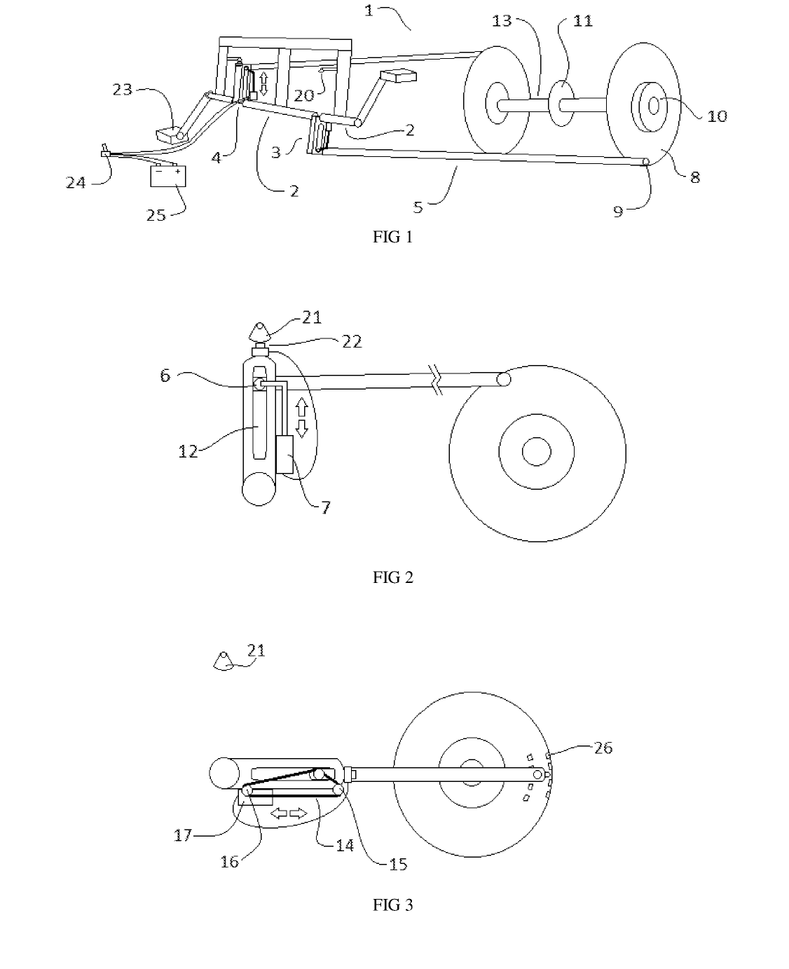

As shown in FIG. 1, the system of the preferred embodiments is a transmission 1 including: at least two axle segments 2; at least one crank arm 3 attached at one end to each axle segment, wherein the space between the at least two crank arms 3 has a gap 4 between the at least two axle segments 2; a connecting rod; a connecting axle 6 rotatably connected to one end of the connecting rod, wherein the connecting axle 6 is attached at either end to the at least two crank arms 3; an actuator 7 adapted to move the attachment point between the connecting axle 6 and the at least two crank arms 3 up and down the length of the at least two crank arms 3; at least one of a wheel 8 and a crank arm with a pivot axle 9 connected at least one of near the periphery of the wheel 8 and near the end of the crank arm, wherein the distal end of the connecting rod 5 is rotatably connected to the pivot axle 9; a one way clutch 10 connected to the wheel 8 and connected to a rear axle 13; a drive gear 11 connected to the rear axle 13 and adapted to output drive power. The transmission 1 of the first preferred embodiments is preferably designed to provide a compact transmission 1 that does not use a derailleur and limits or does not use a chain at all, while being suitable for use on human powered vehicles like bicycles and having the potential in some variations of providing continuous variability in ratio of input axle rotation to output axle rotation. The system of the preferred embodiments may, however, be used for any suitable purpose.

As shown in FIG. 1, each pair of at least two axle segments 2 is spaced with a gap 4 between the axle segments 2. At least one crank arm 3 is attached to the at least two axle segments 2 on either side of the gap 4. A connecting axle 6 is connected between the two crank arms and provides a rotating attachment point for a connecting rod. This allows the connecting rod 5 to be reciprocated by the rotating axle segments 2, where the crank arms rotate along with the axle segments 2. The axle segments 2 are preferably rotatably mounted on thrust bearings, where the thrust bearings are attached to at least one of frame members and a transmission 1 case. This prevents the axle segments 2 from moving along their axis while in use, even though the connecting axles 6 are mounted to be moved along the length of the crank arms, which may prevent the connecting axle 6 from exerting at least one of tension and compression between the crank arms.

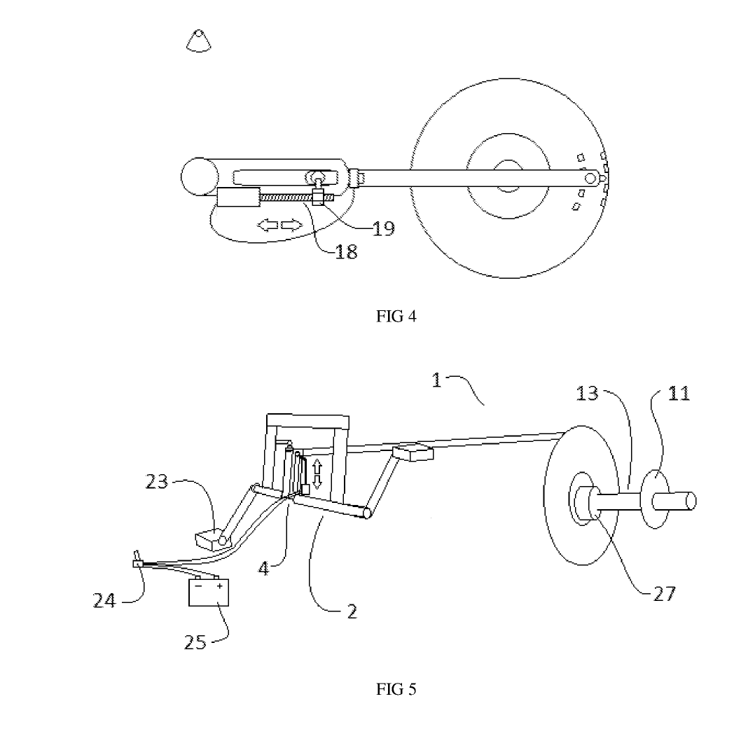

As shown in FIG. 1, the distal end of the at least one connecting rod 5 attaches to a pivot axle 9 on at least one of a wheel 8 and a second crank arm. This allows the reciprocation of the connection rod to drive the at least one of a wheel 8 and a second crank arm in rotation as the axle segments 2 rotate. The at least one of a wheel 8 and a second axle is attached to a one way clutch, and the output of the one way clutch 10 is attached to a rear axle 13. This allows the rear axle 13 to slip in one direction relative to the at least one of a wheel 8 and a second crank arm, which allows the reciprocating connecting rod 5 to drive the rear axle 13 in only one direction as it drives the pivot axle 9 attached to the at least one of a wheel 8 and a second crank arm, and the at least one of a wheel 8 and a second crank arm advances the rear axle 13 in a single direction through the one way clutch. As shown in FIG. 3, in one preferred variation a wheel 8 is attached to the one way clutch 10 with a pivot axle 9 attached near its circumference, and protrusions are attached along the circumference of the wheel 8. The protrusions are placed and designed to engage with the connecting rod 5 when the connecting rod 5 is aligned directly with the center of the rear axle 13, with the at least two crank arms 3 the connecting rod 5 is attached to pointed at least one of directly at and directly away from the center of the rear axle 13. This position can be considered the 0 degree or 180 degree position of the connecting rod. In this position, the connecting rod 5 can potentially reverse direction, so the protrusions are designed and placed to engage with the connecting rod 5 in these positions and push it to farther in the direction of rotation of the wheel 8 to ensure that it does not reverse direction and continues to advance the wheel 8 and the rear axle 13 in the proper direction. In one variation, the protrusions are gear teeth and the gear teeth are shaped and dimensioned to engage a protrusion on the end of the connecting rod 5 only at the positions when the connecting rod 5 is aligned with the center of the rear axle 13. In FIG. 3 protrusions are pictured only on a portion of the circumference, but in a preferred variation the protrusions would run all the way around the circumference so that when the connecting rod 5 aligns with the center of the rear axle 13, there will be a protrusion to engage the connecting rod 5 and continue it's motion in the direction the wheel 8 spins past the point of alignment with the center of the rear axle 13. There may, however, be no protrusions whatsoever. In another preferred variation, as shown in FIG. 1, a second clutch is attached to the rear axle 13 and to the at least one of a wheel 8 and a second crank arm, and the second clutch can be selectively engaged to lock the at least one of a wheel 8 and a second crank arm together so that they do not slip relative to one another. This can continue the motion of the connecting rod 5 in the direction of rotation of the rear axle 13 past the point of alignment between the connecting rod 5 and the center of the rear axle 13, and in an alternative variation it can also allow regenerative braking in a vehicle which has electric power, or combined electric power with another form of power. In one variation, the second clutch may be an actuator 7 that locks the ratchet mechanism in the one way clutch. In another variation, the second clutch may be an automotive style friction clutch. The second clutch may, however, have any suitable design. There may, however, be no second clutch whatsoever. The transmission 1 may, however, be used with a vehicle with no regenerative braking and no electrical power.

As shown in FIG. 1, in a preferred variation, there are at least three axle segments 2 to allow at least four crank arms, at least two connecting rods 5, at least two one way clutches 10, and two or more of at least one of a wheel 8 and a second crank arm attached to each of the at least two one way clutches 10. This allows the connecting axle 6 to be moved on one connecting rod, varying one ratio, while the other connecting rod 5 remains in place to transmit torque from the axle segments 2 to the rear axle 13. The separate one way clutches 10 allow one connecting rod 5 to transmit power while the other connecting rod 5 is shifted to a different position. This allows unbroken transmission 1 of power while the ratio between the input speed and the output speed at the rear axle 13 is varied. In another variation, there are at least five axle segments 2, at least eight crank arms, and at least four connecting rods 5, where two connecting rods 5 are connected to each of the at least two of wheel 8s and second crank arms, where the pairs of connecting rods 5 are attached to crank arms on the axle segments 2 at different angles, where the pairs of connecting rods 5 attached to crank arms attached at different radial angles from the axle segments 2 provide smoother power delivery to the rear axle 13. In this preferred variation, the pairs of connecting rods 5 can be connected to crank arms set at 90 degrees to each other and attached radially to the axle segments 2, so that when one connecting rod 5 is not in an ideal position to transmit power, the other connecting rod 5 will be in a better position. As shown in FIG. 1, preferably an actuator 7 is attached to the crank arm 3 and the actuator 7 is attached to the connecting axle 6 to move the connecting axle 6 up and down the length of the crank arm 3 to vary the ratio between the input and output speed. In one preferred variation, the actuator 7 is a linear actuator 7 and the connecting axle 6 is attached to grooves 12 in the crank arms, and the linear actuator 7 can move the connecting axle 6 up and down the grooves 12 running along the length of the crank arms, varying the distance between the connecting axle 6 and the center of the axle segments 2. This varies the ratio between the axle segment rotational speed and the rear axle 13 output rotational speed. In another preferred variation, a cable loop 14 is wound around a pulley 15 at the top and bottom of the crank arm, and additionally the cable 14 is wrapped around a drum 16 attached to an electrical motor. In this preferred variation, the rotation of the electrical motor causes the cable 14 to move, and the connecting axle 6 is attached to a fixed point on the cable 14 so that the motion of the cable 14 causes the connecting axle 6 to move up and down a groove 12 in the crank arm. In a preferred variation, there may be indentations to the sides of the groove 12 in the crank arm, and the connecting axle 6 may have a spring loaded member in the ends of the connecting axle. The spring loaded member may be shaped and positioned to fit into the indentations on either side of the groove, and an actuator 7 may be adapted to pull the spring loaded member out axially away from the connecting axle, removing it from the indentations, while the spring bias pulls the member back in towards the connecting axle 6 and causes it to re-engage with the indentations on either side of the groove. This provides discrete positions that the connecting axle 6 may be mechanically locked into in order to provide stronger and better set locations for the connecting axle 6 to rest in at different radii from the center of the axle segments 2. The connecting axle 6 may, however, be held in a position relative to the crank arm 3 by any suitable means. In another preferred variation, a nut 19 is attached to the connecting axle 6 and is threaded onto a lead screw 18, where the lead screw 18 is driven by an electric motor 17, where the rotation of the lead screw 18 causes the nut 19 to translate and moves the connecting axle 6 up and down the groove 12 in the crank arm, and this system represents the actuator 7 in this variation. There may, however, be any suitable actuator 7 designed to move the connecting axle 6 along the length of the crank arm. The actuator 7 may, however, be strictly mechanical.

As shown in FIG. 1, in a preferred variation the actuator 7 may be driven by a power source 25, where a circuit between the power source 25 and the actuator 7 includes a switch 24 which allows the ratio between input and output rotational speed to be varied selectively. In one preferred variation the switch 24 is activated manually by a user. In another preferred variation, the switch 24 is operated automatically by at least one of a mechanical and an electrical system which may respond to many conditions suitable for controlling the transmission 1. In a preferred variation, the switch is a dual-pole, dual-throw switch that allows the actuator 7 to be driven in either direction to vary the ratio between input speed and output speed either up or down. There may, however, be any suitable means for controlling the actuator 7.

In one preferred variation, as shown in FIG. 1, a rotational sensor 20 is included to detect the rotational position of the at least two crank arms 3. As shown in FIG. 3, in a further preferred variation a fixed cam 21 may be included, where the cam is designed to trigger an electrical switch 22 in order to energize at least one of the actuator 7 at a given rotational position, and in another variation the actuator is an electric motor 17. This allows the movement of the connecting axle 6 along the crank arm assembly to coincide with the position at which the force is at a minimum in the connecting rod. In one variation, the actuator 7 is triggered by at least one of the rotational sensor 20 and the cam 21 and electrical switch 22 at the position where the connecting rod changes directions, which generally is the position at which the force in the connecting rod is at a minimum, but does not have to be. Generally at least one of these positions coincides with the one way clutch 10 slipping, though it may coincide with any suitable condition. The position of minimum force is equal to or closely related to the position at which it is easiest to move the connecting axle along the crank arm assembly, because the friction and force on the connecting axle is minimized. In a variation, in certain positions the connecting rod 5 may exert a force along the crank arm which is capable to assist in shifting the position of the connecting axle 6 relative to the crank arm assembly, and it may be beneficial to trigger the actuator in a position coinciding with force in the at least one connecting rod 5 that assists with moving the connecting axle 6 in a desired direction. In one variation, this can be accomplished by proper placement of the cam 21. In another variation, this may be accomplished by using software to control the actuator in response to the rotational sensor 20, where the software can select the rotational position ideal for activating the actuator based on the direction in which the connecting axle 6 needs to be moved along the at least two crank arms 3.

In one preferred variation, as shown in FIG. 3, circumferential protrusions 26 are used to make sure that the connecting rod does not stall or reverse direction at the transition point in its range of motion. Without this variation there is some chance that as the crank arm continues to move, it could pull the connecting rod back against the forward motion of the at least of 1) at least one wheel 8, and 2) at least one second crank arm. The circumferential protrusions 26 are designed to engage with at least one of the connecting rod 5 and an attachment or protrusion attached to the connecting rod, so that the inertia of the at least of 1) at least one wheel 8, and 2) at least one second crank arm causes the circumferential protrusions to push the connecting rod past the transition point in the right direction. There may, however, be any suitable means for continuing the motion of the at least one connecting rod 5 in the right direction. In another preferred variation a second clutch 27 which can be selectively activated is attached on the input to the at least of 1) at least one wheel 8, and 2) at least one second crank arm, and the output is attached to the rear axle. In this preferred variation, the clutch can be engaged to prevent slipping between the rear axle and at least of 1) at least one wheel 8, and 2) at least one second crank arm, which allows the connecting rod 5 to be urged past the transition point in the correct direction to continue its motion in the proper direction. There may, however, be no means for continuing the motion of the at least one connecting rod 5.

In one preferred variation, as shown in FIG. 1, pedals 23 may be attached at least one of the axle segments 2 and designed to allow power to be input from the feet of a user. Input power may, however, come from any suitable source.

In a preferred variation, as shown in FIG. 1, there may be a gear attached to the rear axle 13 to transmit output power to a load. In a preferred variation, the load may be at least one wheel 8 of a vehicle. In a further variation, the wheel 8 may be at least one wheel 8 of a bicycle.

As a person skilled in the art will recognize from the previous detailed description and from the figures and claims, modifications and changes can be made to the preferred embodiments of the invention without departing from the scope of this invention defined in the following claims.

I claim:

1) A transmission comprising: at least two axle segments; at least one crank arm attached at one end to each axle segment, wherein the space between the at least two crank arms has a gap between the at least two axle segments; a connecting rod; a connecting axle rotatably connected to one end of the connecting rod, wherein the connecting axle is attached at either end to the at least two crank arms; an actuator adapted to move the attachment point between the connecting axle and the at least two crank arms up and down the length of the at least two crank arms; at least one of a wheel and a second crank arm with a pivot axle at least one of connected near the periphery of the wheel and connected near the end of the second crank arm, wherein the distal end of the connecting rod is rotatably connected to the pivot axle; a one way clutch connected to at least one of the wheel and the crank arm and connected to a rear axle; a drive gear connected to the rear axle and adapted to output drive power.

2) The transmission of claim 1, wherein the actuator is a linear actuator, wherein the connecting axle is slidably coupled to a groove in the at least two crank arms, wherein the linear actuator is coupled to the connecting axle and is adapted to slide the connecting axle to greater and lesser distance from the axle segments, wherein this movement changes the ratio of the number of rotations of the at least two axle segments to the number of rotations of the rear axle.

3) The transmission of claim 1, wherein the actuator is a driven cable loop, wherein the cable is passed through a pulley at either end of the crank arm, wherein the cable is wound around a drum, wherein the drum is rotated by an electric motor, wherein the connecting axle is slidably coupled to a groove in the at least two crank arms, wherein the connecting axle is coupled to a point on the cable and wherein the movement of the cable is adapted to slide the connecting axle to greater and lesser distance from the axle, wherein this movement changes the ratio of the number of rotations of the at least two axle segments to the number of rotations of the rear axle.

4) The transmission of claim 1, wherein the actuator is an electric motor coupled to a lead screw, wherein the electric motor is adapted to turn the lead screw, wherein a threaded nut is threaded onto the lead screw, wherein the connecting axle is slidably coupled to a groove in the at least two crank arms, wherein the connecting axle is coupled to the threaded nut and wherein the rotation of the lead screw causes the translation of the threaded nut, wherein the threaded nut is adapted to slide the connecting axle to greater and lesser distance from the axle, wherein this movement changes the ratio of the number of rotations of the at least two axle segments to the number of rotations of the rear axle.

5) The transmission of claim 2, wherein there are at least three axle segments, at least four crank arms, at least two connecting axles, at least two actuators, at least two connecting rods, at least two wheels, and at least two one way clutches attached to the rear axle, wherein the at least two actuators can be individually driven so that the drive force can be continuously transmitted to the rear axle by the second connecting rod while the first connecting axle is moved in distance from the axle segments, and then the first connecting rod can continuously transmit drive force to the rear axle while the second connecting axle is moved.

6) The transmission of claim 3, wherein there are at least three axle segments, at least four crank arms, at least two connecting axles, at least two actuators, at least two connecting rods, at least two wheels, and at least two one way clutches attached to the rear axle, wherein the at least two actuators can be individually driven so that the drive force can be continuously transmitted to the rear axle by the second connecting rod while the first connecting axle is moved in distance from the axle segments, and then the first connecting rod can continuously transmit drive force to the rear axle while the second connecting axle is moved.

7) The transmission of claim 4, wherein there are at least three axle segments, at least four crank arms, at least two connecting axles, at least two actuators, at least two connecting rods, at least two wheels, and at least two one way clutches attached to the rear axle, wherein the at least two actuators can be individually driven so that the drive force can be continuously transmitted to the rear axle by the second connecting rod while the first connecting axle is moved in distance from the axle segments, and then the first connecting rod can continuously transmit drive force to the rear axle while the second connecting axle is moved.

8) The transmission of claim 1, wherein there is a rotational sensor adapted to sense the angular position of at least one of A) one of the axle segments, and B) one of the crank arms, wherein the sensor is adapted to trigger the actuator to move the connecting axle when it reaches at least one of 1) a certain angular position and 2) over a given range of angular positions, wherein the at least one of 1) a certain angular position and 2) over a given range of angular positions is chosen to coincide with the angular position at which the at least one connecting rod will experience the lowest force.

9) The transmission of claim 8, wherein the sensor comprises a fixed cam attached to at least one of the transmission frame and the transmission case, and an electrical switch attached to at least one crank arm, wherein the fixed cam triggers the electrical switch when the at least one crank arm passes the fixed cam.

10) The transmission of claim 5, wherein there is a rotational sensor adapted to sense the angular position of at least one of A) one of the axle segments, and B) one of the crank arms, wherein the sensor is adapted to trigger the actuator to move the connecting axle when it reaches at least one of 1) a certain angular position and 2) over a given range of angular positions, wherein the at least one of 1) a certain angular position and 2) over a given range of angular positions is chosen to coincide with the angular position at which the at least one connecting rod will experience the lowest force.

11) The transmission of claim 6, wherein there is a rotational sensor adapted to sense the angular position of at least one of A) one of the axle segments, and B) one of the crank arms, wherein the sensor is adapted to trigger the actuator to move the connecting axle when it reaches at least one of 1) a certain angular position and 2) over a given range of angular positions, wherein the at least one of 1) a certain angular position and 2) over a given range of angular positions is chosen to coincide with the angular position at which the at least one connecting rod will experience the lowest force.

12) The transmission of claim 7, wherein there is a rotational sensor adapted to sense the angular position of at least one of A) one of the axle segments, and B) one of the crank arms, wherein the sensor is adapted to trigger the actuator to move the connecting axle when it reaches at least one of 1) a certain angular position and 2) over a given range of angular positions, wherein the at least one of 1) a certain angular position and 2) over a given range of angular positions is chosen to coincide with the angular position at which the at least one connecting rod will experience the lowest force.

13) The transmission of claim 10, wherein pedals are attached to at least one of the axle segments, wherein the pedals are adapted to be driven by a user's feet.

14) The transmission of claim 11, wherein pedals are attached to at least one of the axle segments, wherein the pedals are adapted to be driven by a user's feet.

15) The transmission of claim 1, wherein pedals are attached to at least one of the axle segments, wherein the pedals are adapted to be driven by a user's feet.

16) The transmission of claim 8, wherein a gear shift switch energizes a circuit between a power source and the actuator when it is desired to change the rotational ratio between the axle segments and the rear axle.

17) The transmission of claim 10, wherein a gear shift switch energizes a circuit between a power source and the actuator when it is desired to change the rotational ratio between the axle segments and the rear axle.

18) The transmission of claim 12, wherein a gear shift switch energizes a circuit between a power source and the actuator when it is desired to change the rotational ratio between the axle segments and the rear axle.

19) The transmission of claim 10, further comprising circumferentially spaced protrusions attached to the wheel, wherein the protrusions are adapted to engage the connecting rod at least twice per rotation when the crank arm is pointed directly at and directly away from the center of the rear axle, wherein the engagement between the members and the connecting rod is adapted to push the connecting rod further in the direction of the rotation of the wheel.

20) The transmission of claim 10, wherein a second clutch adapted to be engaged and disengaged is attached to the wheel and attached to the rear axle, wherein the second clutch is adapted to prevent slipping of the wheel relative to the rear axle when selectively engaged.

21) The transmission of claim 11, wherein a gear shift switch energizes a circuit between a power source and the actuator when it is desired to change the rotational ratio between the axle segments and the rear axle.
